(19) United States
(12) Patent Application Publication
(10) Pub. No.: US 2005/0091355 A1
(43) Pub. Date: Apr. 28, 2005

(54) Providing a necessary level of security for computers capable of connecting to different computing environments

(75) Inventors: Susann Marie Keohane, Austin, TX (US); Shawn Patrick Mullen, Buda, TX (US); Johnny Meng-Han Shieh, Austin, TX (US); Gerald Francis McBrearty, Austin, TX (US); Jessica Murillo, Hutto, TX (US)

Correspondence Address: IBM CORP (BLF), c/o BIGGERS & OHANIAN, LLP, 504 LAVACA STREET, SUITE 970, AUSTIN, TX, 78701-2856, US

(73) Assignee: INTERNATIONAL BUSINESS MACHINES CORPORATION, ARMONK, NY (US)

(21) Appl. No.: 10/677,660

(22) Filed: Oct. 2, 2003

(51) Int. Cl. G06F 15/16; G06F 15/173

(52) U.S. Cl. 709/223; 709/224; 709/217

(57) ABSTRACT

Providing a necessary level of security for a computer capable of connecting to different computing environments, including monitoring (402) a type of connection between the computer and a network in a current computing environment; determining (406) a security level of data (408) before sending the data across the network; storing (416) the data in a buffer instead of sending the data across the network if the connection to the network lacks a security control (410) required for the determined security level of the data; and sending (420) the data from the buffer when the computer is connected to a changed computing environment having a new type of connection that has (412) the security control required for the data.

### BACKGROUND OF THE INVENTION

1. Field of the Invention

The field of the invention is data processing, or, more specifically, methods, systems, and products for providing a necessary level of security for computers capable of connecting to different computing environments.

2. Description of Related Art

One aspect of mobile computing is the fast growing use of wireless routers or wireless access points sometimes known as ‘hot spots’ which allow portable computer users to do their work while on the move. Hot spots are found now in coffee shops, hotels, lounges, book stores, restaurants, airports, and so on. Wired Internet connections are in many hotel rooms. Such mobile computing, however, can lead to security risks because portable connections either through wireless connections or to a random live wall connection can result in a user's connecting to the Internet through insecure connections or through unknown levels of security. Users can inadvertently send confidential data in the form of email, instant messaging, World Wide Web (HTTP) communications, or other network communications, that can be captured and analyzed by would be snoopers. There is an ongoing need, therefore, for improvement in data communication security methods and systems for mobile computing.

### SUMMARY OF THE INVENTION

Methods, systems, and products are disclosed providing a necessary level of security for a computer capable of connecting to different computing environments. Typical embodiments include monitoring a type of connection between the computer and a network in a current computing environment. Monitoring a type of connection may be carried out by periodically determining the type of connection between the computer and the network, or monitoring a type of connection may be carried out by in an event-driven fashion. Event driven determination may be carried out when processes implementing embodiments of the invention are invoked, as upon power-up of a computer on which they are installed. Alternatively, when determining a security level results in a determination that data to be transmitted requires at least some level of security, event-driven determining of the type of connection is carried out in response to such determination.

Typical embodiments include determining a security level of data before sending the data across the network. Determining a security level of data before sending the data across the current network may be implemented by reading the security level of data from a markup element embedded in the data or by reading the security level of data from meta-data in a header in a network message.

Typical embodiments include storing data in a buffer instead of sending the data across the network if the connection to the network lacks a security control required for the determined security level of the data. Such embodiments typically also include sending the data from the buffer when the computer is connected to a changed computing environment having a new type of connection that has the security control required for the data. Many embodiments also include returning a non-fatal error to a

sending program if the connection to the network lacks a security control required for the data. Such embodiments often also include the sending program's informing a user that the data will be held in a security buffer until the computer is connected to a changed computing environment having a new type of connection that has the security control required for the data. Many such embodiments include the sending program's prompting a user with the option to create a secure tunnel for transmission of the data.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 depicts an exemplary architecture for data communications in which various exemplary embodiments of the present invention may be implemented.

FIG. 2 sets forth a block diagram of automated computing machinery comprising a computer useful in computing environments according to embodiments of the present invention.

FIG. 3 sets forth a block diagram of an exemplary data communications protocol stack.

FIG. 4 sets forth a line drawing of a data entry screen on an email client improved according to embodiments of the present invention.

FIG. 5 sets forth a flow chart illustrating an exemplary method for providing a necessary level of security for a computer capable of connecting to different computing environments.

FIG. 6 sets forth a block diagram illustrating secure tunneling according to the IPsec protocol.

FIG. 7 sets forth a flow chart illustrating a further exemplary method for providing a necessary level of security for a computer capable of connecting to different computing environments.

### DETAILED DESCRIPTION OF EXEMPLARY EMBODIMENTS

### Introduction

The present invention is described to a large extent in this specification in terms of methods for providing a necessary level of security for computers capable of connecting to different computing environments. Persons skilled in the art, however, will recognize that any computer system that includes suitable programming means for operating in accordance with the disclosed methods also falls well within the scope of the present invention. Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit.

The invention also may be embodied in a computer program product, such as a diskette or other recording medium, for use with any suitable data processing system. Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Providing Necessary Levels of Security for Mobile Computing

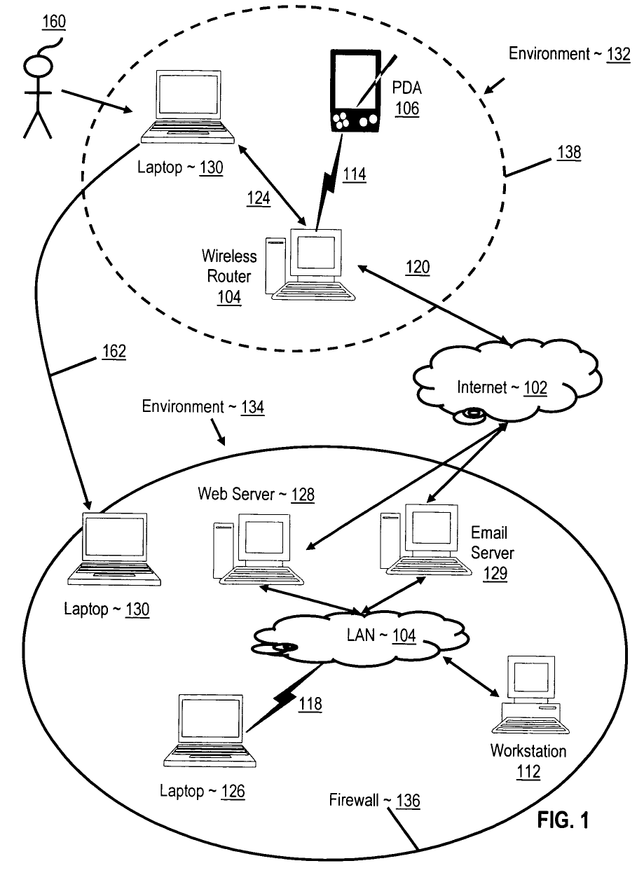

Exemplary methods, systems, and products for providing a necessary level of security for computers capable of connecting to different computing environments are further explained with reference to the accompanying drawings, beginning with FIG. 1. Providing a necessary level of security for computers capable of connecting to different computing environments according to exemplary embodiments of the present invention is implemented generally by monitoring a type of connection between a computer and a network in a current computing environment, determining a security level of data to be sent across the network, and storing the data in a buffer instead of sending the data across the network if the connection to the network lacks a security control required for the determined security level of the data. Later when the computer is connected to a changed computing environment having a new type of connection that has the security control required for the data, the data is sent from the buffer to its destination.

A computing environment is a group of computers having available to them similar levels of data communications security. FIG. 1 depicts an exemplary architecture for data communications in which various exemplary embodiments of the present invention may be implemented. In particular, FIG. 1 depicts two exemplary computing environments. Computing environment 132 includes laptop computer 130 and PDA 106 connected through wireline connection 124 and unencrypted wireless link 1 14 respectively through a wireless router 104 to an internet 102.

Wireless router 104 is a computer that provides a wireless access point, a communication hub through which wireless devices 130 and 106 connect to a wired network 102. To the extent that a computing environment provides some level of wireless security, such levels of wireless security generally are made available through wireless access points such as router 104. Wired networks that support wireless access, such as, for example, local area network (“LAN”) 104, typically include one or more wireless access points (not shown on FIG. 1).

An “internet” (uncapitalized) is any set of networks interconnected with routers. In this specification, the term “Internet” (capitalized) refers to the well-known global network connecting millions of computers utilizing various protocols, including the Internet Protocol or ‘IP’ as the network layer of their networking protocol stacks. The Internet is characterized by massive difficulties regarding data communications security, and this is one of the challenges with which this specification is concerned. That is, as persons of skill in the art will recognize, internet 102 may be, and indeed often is, the Internet, and use of low levels of security in connecting to it represents significant risks to data communications.

The group of computers forming computing environment 132 have available to them similar levels of data communications security representing in effect, no particular level of security at all, a fact that is symbolized by the dashed line 138 delimiting computing environment 132. Examples of computing environments of the kind exemplified by computing environment 132 include coffee shops that provide hotspots for wireless laptop connections to the Internet and hotels that provide wireline Internet connections in each room.

Computing environment 134, on the other hand, is characterized by availability of higher levels of security. Computing environment 134 includes laptop computer 126, workstation 112, email server 129, and web server 128, all connected through local area network (“LAN”) 104. Computing environment 134 is disposed entirely behind corporate firewall 136 which scrutinizes all data communications in and out of computing environment 134. Both laptop 126 and workstation 112 have available support for tunneling connections to other computers across the internet 102.

Also in computing environment 134, laptop 126 is connected to the corporate LAN 104 through an encrypted wireless connection 118. Examples of encrypted wireless connections useful in accordance with various embodiments of the present invention include Wired Equivalent Privacy (“WEP”), Wi-Fi Protected Access (“WPA”), and other as will occur to those of skill in the art.

WEP is a security protocol for wireless LANs defined in the IEEE 802.11b standard. WEP is intended to provide a similar level of security as that of a wired network connection. By comparison with wireless LANs, wired LAN connections are inherently more secure because wired LAN connections are protected by the physical nature of their structure, typically having some or all part of the network inside a building that can be protected from unauthorized access. Wireless LANs, which are implemented over radio waves, do not have the same physical structure and therefore are more vulnerable to tampering. WEP aims to provide security by encrypting data transmitted over radio waves so that it is protected as it is transmitted from a client to an access point or from one end point to another. WEP functions at the lowest layers of the OSI protocol stack—the data link layer and the physical layer.

WPA is a ‘Wi-Fi’ standard, that is, an IEEE 802.11 standard, designed to improve the security features of WEP. WPA, however, is an interim standard eventually to be replaced by the IEEE 802.11i standard. WPA is usually implemented as software upgrades for hardware in existing Wi-Fi products enabled for WEP, but WPA improves WEP with better data encryption through the Temporal Key Integrity Protocol (“TKIP”). WPA also improves WEP by adding user authentication and public key encryption through the Extensible Authentication Protocol (“EAP”).

The examples of computing environments illustrated in FIG. 1 are for explanation, not for limitation. Computing environments may include additional servers, clients, routers, and other devices not shown in FIG. 1 as will occur to those of skill in the art. Networks in or associated with such computing environments may support many data communications protocols, Simple Mail Transfer Protocol (“SMTP”), the Post Office Protocol (“POP”), the Hypertext Transport Protocol (“HTTP”), the Wireless Access Protocol (“WAP”), the Handheld Device Transport Protocol (“HDTP”), the Transport Control Protocol/Internet Protocol Suite (“TCP/IP”), and others as will occur to those of skill in the art. FIG. 1 presents examples of heterogeneous computing environment in which various embodiments of the present invention may be implemented, not as an architectural limitation of the present invention.

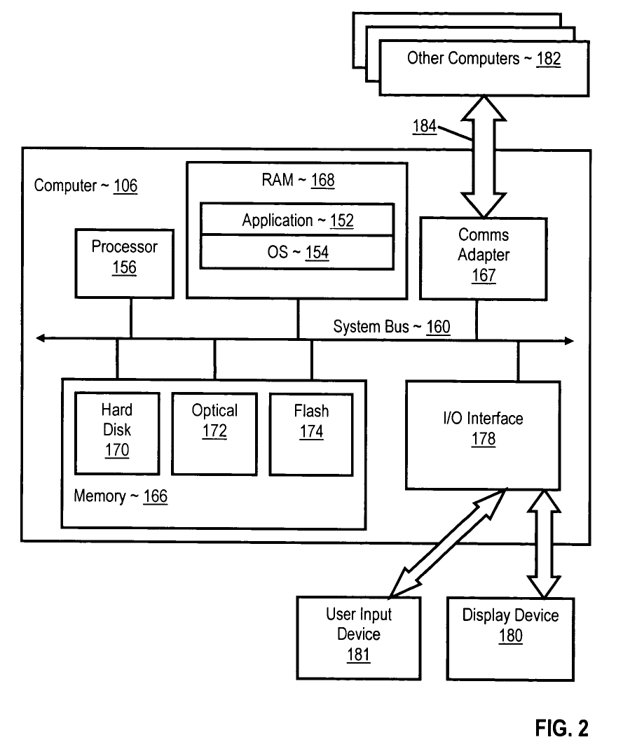

A “computer” is any automated computing machinery. The term “computer” as used in this specification therefore includes not only general purpose computers such as laptops, personal computer, minicomputers, and mainframes, but also includes devices such as personal digital assistants (“PDAs), network enabled handheld devices, internet-enabled mobile telephones, and so on. FIG. 2 sets forth a block diagram of automated computing machinery comprising a computer 106 useful in computing environments according to embodiments of the present invention. The computer 106 of FIG. 2 includes at least one computer processor 156 or ‘CPU’ as well as random access memory 168 (“RAM”). Stored in RAM 168 is an application program 152. Application programs useful in accordance with various embodiments of the present invention include browsers, email clients, TCP/IP clients, and so on, as will occur to those of skill in the art.

When a computer like computer 106 is operated as an email client, application 152 includes email client application software. When a computer like computer 106 is operated as a browser, application 152 includes browser application software. Examples of email application software include, for example, Microsoft Microsoft's Outlook™, Qualcomm's Eudora™, or Lotus Notes™. Examples of browser application software include Microsoft Outlook™, Netware Netscape™, and NCSA Mosaic™. Transport and network layer software clients such TCP/IP clients are typically provided as components of operating systems, including Microsoft Windows™, IBM's AIX™, Linux™, and so on. Also stored in RAM 168 is an operating system 154. Operating systems useful in computers or according to embodiments of the present invention include Unix, Linux™, Microsoft NT™, and others as will occur to those of skill in the art. Application software and operating systems may be improved by use of plug-ins, kernel extensions, or modifications at the source code level in accordance with embodiments of the present invention, or, alternatively, completely new application or operating system software may be developed from scratch to implement embodiments of the present invention.

The example computer 106 of FIG. 2 includes computer memory 166 coupled through a system bus 160 to the processor 156 and to other components of the computer. Computer memory 166 may be implemented as a hard disk drive 170, optical disk drive 172, electrically erasable programmable read-only memory space (so-called ‘EEPROM’ or ‘Flash’ memory) 174, RAM drives (not shown), or as any other kind of computer memory as will occur to those of skill in the art.

The example computer 106 of FIG. 2 includes communications adapter 167 that implements connections for data communications 184 to other computers 182. Communications adapters implement the hardware level of data communications connections through which client computers and servers send data communications directly to one another and through networks. Examples of communications adapters include modems for wired dial-up connections, Ethernet (IEEE 802.3) adapters for wired LAN connections, and 802.11 adapters for wireless LAN connections.

The example computer of FIG. 2 includes one or more input/output interface adapters 178. Input/output interface adapters in computers implement user-oriented input/output through, for example, software drivers and computer hardware for controlling output to display devices 180 such as computer display screens, as well as user input from user input devices 181 such as keyboards and mice.

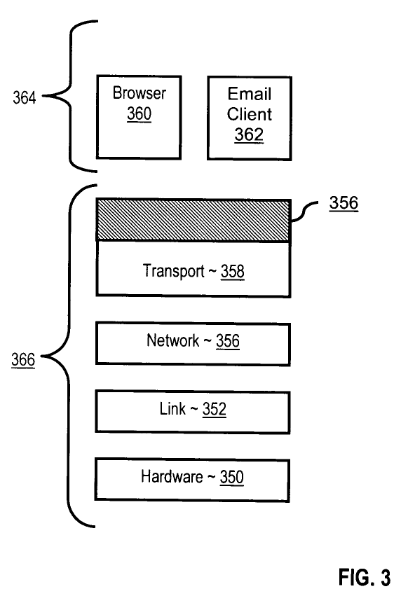

Software architectural aspects of the present invention are further explained with referenced to FIG. 3. FIG. 3 sets forth a block diagram of an exemplary data communications protocol stack, similar to the well known OSI standard for such protocol stacks. The stack of FIG. 3 includes a hardware layer 350, a link layer 352, a network layer 356, a transport layer 358, and an application layer 364. The software aspects of the hardware layer 350, the link layer 352, the network layer 356, and the transport layer 358 typically are considered components of an operating system, while protocol layers above those 364 typically are considered applications. Browsers 360 and email clients 362 are examples of application software that implement application-level data communications protocols such as HTTP, SMTP, POP, and other as will occur to those of skill in the art.

The Transmission Control Protocol (“TCP”) is an example of a transport layer protocol 358, and the Internet Protocol (“IP”) is an example of a network layer protocol 356. TCP and IP are used together so often in the transport layer and the network layer, that they are generally referred to an making up a ‘suite’ of data communication software often referred to together as “TCP/IP.” Embodiments of the present invention in their software aspects are preferably implemented and installed as a daemon operating just above the transport layer 356 in the protocol stack or as an improvements of transport layer software. Although it is not a limitation of the present invention, because many kinds of transport software and many kinds of network software are useful in various embodiments of the present invention, it is often the case that processing steps of the present invention are implemented in software as improvements of or additions to TCP or TCP/IP.

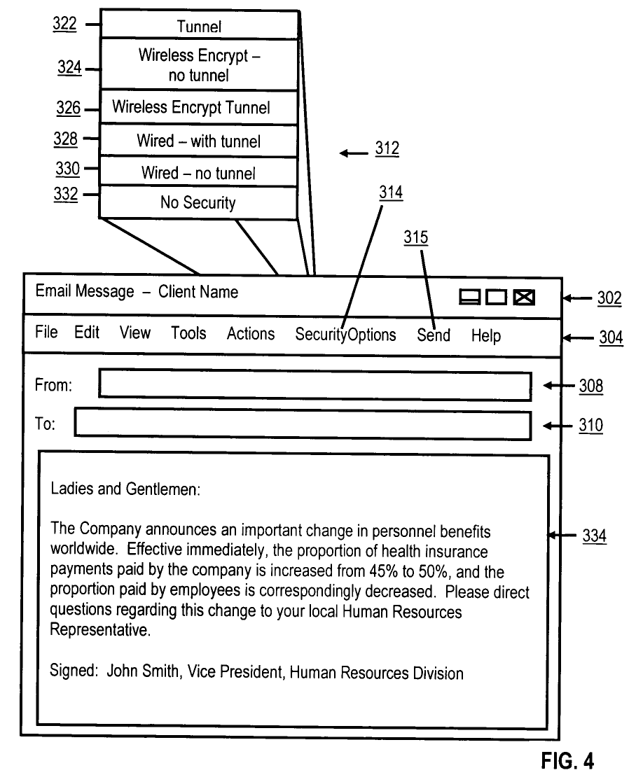

Exemplary embodiments of the present invention are further explained with reference to FIG. 4. FIG. 4 sets forth a line drawing of a data entry screen on an email client improved according to embodiments of the present invention. The data entry screen of FIG. 4 includes a title line 302 that displays the fact that the document under edit is an email document and the name of the email client (“Client Name”). In actual embodiments, the ‘Client Name’ is often the actual name of an email client application such as Lotus Notes™, Microsoft Outlook™, or Qualcomm Eudora™.

The data entry screen of FIG. 4 includes a horizontal menu 304 containing the usual menu items such as ‘File,’ ‘Edit,’ ‘View,’ and so on. In addition to the usual kind of menu items for such an email screen, the horizontal menu 304 contains a new item labeled ‘SecurityOptions’ 314 referring to security options as improvements according to embodiments of the present invention. Invoking the SecurityOptions menu item 314 displays the pull-down menu 312 which makes available several functions supporting security options according to embodiments of the present invention.

The exemplary email client of FIG. 4 is programmed to insert in meta-data in an email message, in response to a user's selecting pull-down menu item 322, a required security level for the data in the email message of at least an IP tunnel, regardless whether the connection is wired or wireless. Similarly, a user's selecting item 324 inserts meta-data identifying a required level of security that includes at least encryption for wireless connections. Item 326 requires an encrypted wireless connection in addition to tunneling. When the connection is wired, selecting item 328 requires a tunnel, useful when a user connects a laptop to an Ethernet port in a hotel room outside any corporate firewall. Selecting item 330 encodes meta-data requiring no tunnel for a wired connection, appropriate when, for example, the user knows the computer in question is connected behind a corporate firewall. Selecting item 332, ‘No Security,’ advises the sending application, the example email client of FIG. 4, to insert no meta-data regarding security—or alternatively to insert meta-data affirmatively stating ‘no security.’ A ‘no security’ level of security is in fact useful for many casual kinds of data communications.

That fact the exemplary sending program of FIG. 4 is represented as an email client is not a limitation of the present invention. On the contrary, many email clients are useful in various embodiments of the present invention, including HTTP clients or browsers, microbrowsers on network enabled wireless devices, TCP/IP clients, tunneling clients such as IPsec clients or PPTP clients, and so on. The use of all such sending programs, and others as will occur to those of skill in the art, is well within the scope of the present invention.

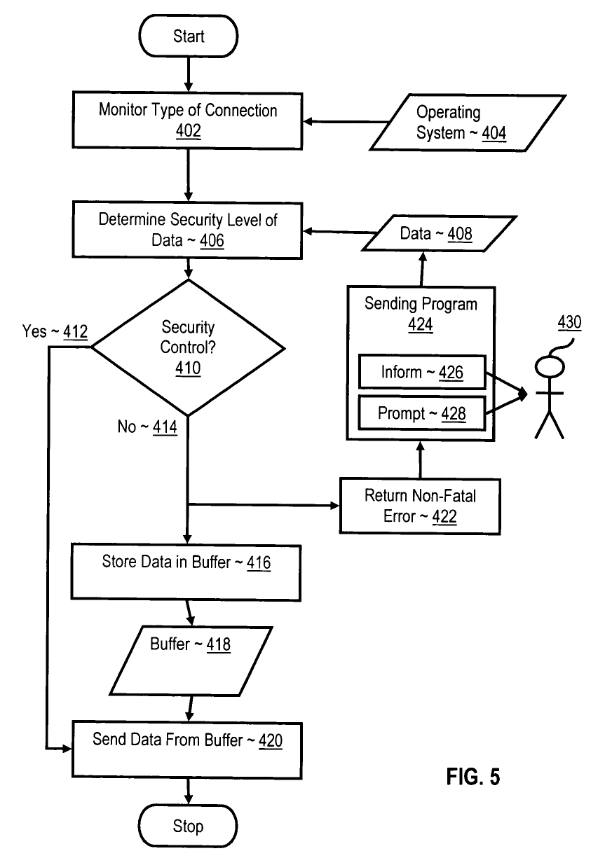

FIG. 5 sets forth a flow chart illustrating an exemplary method for providing a necessary level of security for a computer capable of connecting to different computing environments. The method of FIG. 5 includes monitoring 402 a type of connection between the computer and a network in a current computing environment. The ‘type of connection’ refers generally to the security controls available for data communications connections in the computing environment. Available security controls are determined according to standard operating system calls, services, and data structures. In IBM's AIX, for example, the operating system calls LSCFG, LSATTR, LSCONN, LSDEV, and LSPARENT return data indicating the status of data communications devices, including available security controls.

Monitoring 402 a type of connection may be accomplished by periodically determining the type of connection between the computer and the network. A process programmed to carry out the step of periodically determining the type of connection may, for example, be programmed to loop by sleeping for some period of time, waking to check the types of connection available, sleeping, waking and checking, and so on, for as long as the computer is on. When the daemon or process wakes to monitor the connection type or security level, it may initiate an Application Program Interface (“API”) call such as a device driver ioctl( ) call or a system call to a security library asking the operating system for the security program running at the time.

Monitoring 402 a type of connection may include event-driven determining of the type of connection between the computer and the network. In one example of an event-driven determining of the type of connection, the steps of the method are carried out by a software process and event-driven determining of the type of connection is carried out whenever the process is invoked. In an example where a TCP/IP client is enhanced according to embodiments of the present invention and installed on a laptop computer, if the TCP/IP client is run every time the laptop is powered up, then the determination of the type of connection is carried every time the laptop is powered up.

In another example of event-drive determining of the type of connection, determining 406 a security level results in a determination that data to be transmitted requires at least some level of security and event-driven determining of the type of connection is carried out in response to such determination. It is possible, indeed common, that data to be transmitted across a network either contains no meta-data indicating a required level of security or contains meta-data affirmatively indicating that no particular level of security is required. To the extent that no particular level of security is needed, then there is no need to determine the type of connection. When, however, a software process carrying out steps of the present invention reads from data to be transmitted across a network meta-data indicating that some level of security other none is required, the process treats that determination as a event in response to which the process determines the type of connection and the level or levels of security available for sending data across a network.

The exemplary method of FIG. 5 also includes determining 406 a security level of data 408 before sending the data across the network. Determining 406 a security level of data before sending the data across the current network is preferably accomplished by reading the security level of data from meta-data in a header in a network message. Determining 406 a security level of data before sending the data across the current network also may be carried out by reading the security level of data from a markup element embedded in the data.

“Meta-data” means data describing other data. The term is used in this disclosure in particular to mean data describing data to be sent across a network. Meta-data is preferably set forth within the data to be sent across the network. Meta-data includes data describing a required security level for data to be sent across a network. Data is typically sent across networks in data communications messages having forms defined in data communications protocols, HTTP, SMTP, TCP/IP, and so on. Data communications messages generally are composed of a ‘header’ and a ‘body.’ The header includes various fields such as a sender's identification, addressees' identifications, source address, destination address, route tracing data, and so on. The body typically is text or other data comprising message content. It is useful to distinguish meta-data from a message body and other usual header fields.

Some email protocols, including SMTP for example, support optional additional header fields in which meta-data may be placed. In the example of SMTP, so-called ‘optional fields’ are defined in the standard, including a required syntax: a field name (that must not duplicate a standard field name) followed by a colon followed by unstructured text. Consider the following example:
From: John Doe <jdoe@machine.example>
To: Mary Smith <mary@example.net>
Subject: Saying Hello
Date: Fri, 21 Nov. 2003 09:55:06
Message-ID: <1234@local.machine.example>
Required-Security: wireless encrypted
Mary,
This is a message just to say ‘hello.’ I enjoyed meeting you at the conference last week. Let's stay in touch.
Regards,
John

In this example, the first five fields, ‘From:,’ ‘To:,’ ‘Subject:,’ ‘Date:,’ and ‘Message-ID’ are standard SMTP fields. The last field, ‘Required-Security,’ is a new meta-data field a required security level of the data in the email message. The Required-Security field in this example specifies “wireless encrypted,” meaning that any wireless connection to a network through which this example message is to be sent is to be an encrypted connection, that is, a connection using WEP, WPA, or some other form of wireless connection providing data encryption.

Another way of including meta-data in data to be sent across a network is to insert the meta-data in the message body itself. SMTP, for example, uses this method to insert time stamps on messages when they are relayed through email servers and when they are received in destination servers. In the following email message, for example:
From: John Doe <jdoe@machine.example>
To: Mary Smith <mary@example.net>
Subject: Saying Hello
Date: Fri, 21 Nov. 2003 09:55:06
Message-ID: <1234@local.machine.example>
<Required-Security: wireless encrypted>
Mary,
This is a message just to say ‘hello.’ I enjoyed meeting you at the conference last week. Let's stay in touch.
Regards,
John,
   the meta-data element identifying required security level for the email message as requiring wireless encryption is delimited with angle-brackets < >and inserted at the beginning of the body of the message: <Required-Security: wireless encrypted>.

Many email systems support message formatting in the Hypertext Markup Language (“HTML”). In this example:

<HTML>

<HEAD>

<META name=“Required-Security”

content=“wireless encrypted”>

</HEAD>
<BODY>

Mary,
This is a message just to say ‘hello.’ I enjoyed meeting
you at the conference last week. Let's stay in touch.
Regards,
John

</BODY>

</HTML>

the meta-data element identifying the required security level for the message data is set forth in an HTML <META>tag. In addition to optional protocol header fields, insertion in message body segments, and insertion in HTML <META>tags, other methods of including in data to be sent across a network meta-data identifying required security levels will occur to those of skill in the art, and all such methods are well within the scope of the present invention.

The exemplary method of FIG. 5 also includes storing 416 the data in a buffer 416 instead of sending the data across the network if the connection to the network lacks a security control 410 required for the determined security level of the data. The exemplary method of FIG. 5 also includes sending 420 the data from the buffer when the computer is connected to a changed computing environment having a new type of connection that has 412 the security control required for the data. Readers will recognize this aspect as one of the principal benefits of the present invention. An example useful for explanation is a user's beginning operations on a laptop (reference 126, FIG. 1) in a secure computing environment like the one illustrated at reference 134 on FIG. 1. So long as the user remains in computing environment 134, determining a type of connection will result in determinations that encrypted wireless connections are available, as well as tunneled connections, and so on. Later the user carries the laptop 126 to the less secure computing environment 132. Now when the laptop powers up in the less secure environment, the laptop determines by use of operating system calls the types of connections available and discovers that the computing environment 132 does not support encrypted wireless connections. When the user then attempts to send an email message marked in its meta-data as requiring encryption for wireless transmissions, the transport layer client (often TCP), which is enhanced according to the present invention, compares the types of connection available in the computing environment 132 with the level of security identified in the email message, determines that the required level of security is not available in the computing environment, and buffers the email message rather than sending it.

The method of FIG. 5 also preferably includes returning 422 a non-fatal error to a sending program 424 if the connection to the network lacks a security control required for the data. The method of FIG. 5 also preferably includes the sending program's informing 426 a user 430 that the data will be held in a security buffer until the computer is connected to a changed computing environment having a new type of connection that has the security control required for the data. Continuing the example from the previous paragraph, the sending program 424 in this example is an email client such as Microsoft Outlook™. The email client attempted to open a TCP connection to its SMTP server to send the email message, but the enhanced TCP client determined that the required security level is not available, buffered the email message, and returned an error message to the calling program, the sending program, the email client, notifying the sending program that the email message would be buffered for now and sent later. The sending program, in this case the email client, in turn presents a dialogue box on the display of the laptop notifying the user that the email message has been buffered until such time as the laptop is moved to a computing environment that provides the required level of security for the data in the email message.

The method of FIG. 5 also preferably includes the sending program's prompting 428 a user 430 with the option to create a secure tunnel for transmission of the data. A “tunnel” is a data communications technique in which one protocol layer sends data via another protocol layer's network connections. Tunneling works by encapsulating one protocol layer's message data within packets carried by another network protocol layer. Examples of tunneling protocols include the IP Security Protocol (“IPsec”) and the Point to Point Tunneling Protocol (“PPTP”). PPTP is promulgated by the PPTP Forum which consists of Ascend Communications, Microsoft Corporation, 3Com/Primary Access, ECI Telematics, and U.S. Robotics. IPsec is a set of protocols developed by the Internet Engineering Task Force (IETF”). Both IPsec and PPTP work by encrypting IP messages and encapsulating the encrypted messages in further IP packets.

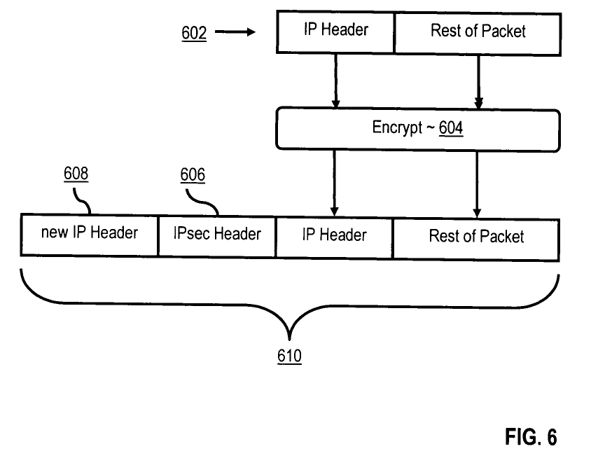

An example of IPsec tunneling is shown in a block diagram in FIG. 6. In the example of FIG. 6, a normal IP packet 602 is encrypted 604. An IPsec header 606 and a second IP header 608 are added to the encrypted packet. Then the entire new packet 610 is sent through the normal IP layer of the data communications protocol stack as an ordinary IP packet. When the packet arrives at a destination node, the new IP header 608 and the IPsec header 606 are discarded. The original packet is then unencrypted and handed off to the IP layer of the protocol stack to be treated like an ordinary IP packet. When a TCP client, for example, prompts 428 a user 430 with an option to create a secure tunnel for transmission of data and the user accepts the option, a TCP client enhanced according to embodiments of the present invention then calls a tunneling client, such as an IPsec client or PPTP client for transmission of the actual IP packets.

It is useful to note that an advantage of using tunneling is that the availability of tunneling as a level of security is independent of the level of security available in the computing environment itself. That is, whether tunneling is available as a level of security for sending data across a network depends on availability of a tunneling client on the sending computing and tunneling software on the destination node. When the less secure computing environment (132 on FIG. 1) is a coffee shop with unencrypted wireless access point, for example, whether tunneling is available depends only on the software installed on the laptop and the software on the computer representing the destination of any particular data to be sent across the network—and not on the level of security available from the wireless access point in the coffee shop itself.

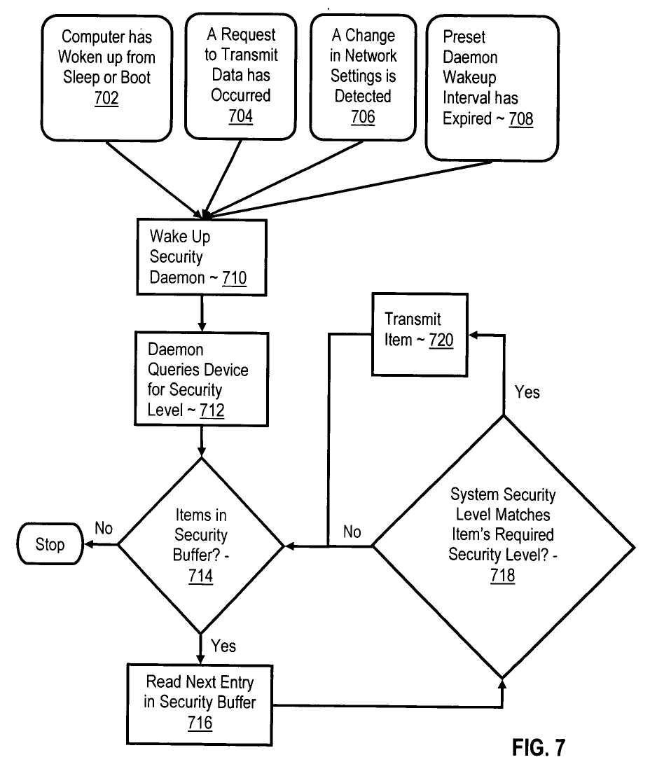

FIG. 7 sets forth a flow chart illustrating a further exemplary method for providing a necessary level of security for a computer capable of connecting to different computing environments. In the method of FIG. 7, a process programmed to carry out the steps of the method is referred to as a ‘daemon’ or a ‘security daemon.’ Alternative processes 702-708 represent several ways of awakening the security daemon 710. In the method of FIG. 7, the security daemon may be awakened when the computer on which it is installed is booted or returns from a sleep command 702. The security daemon may be awakened in an event-driven fashion upon a request to transmit data 704. The daemon may be awakened by a change in network settings 706. Or the daemon may be awakened by expiration of a preset interval 708.

After the daemon is awakened, the daemon queries a data communications device for its security level through use of API calls or system calls 712. After the daemon has determined the available security level, the daemon then operates in a loop in which it first checks whether there are waiting in a security buffer any items of data to be sent or transmitted across a network. If no items are waiting in the buffer, the daemon exits, allowing the computer or other processes to do other work. The daemon may use a sleep command for this, so that the daemon will automatically again awaken after a sleep interval.

If one or more data items are waiting in the buffer for transmission, the daemon reads an item from the buffer 716 and checks whether the available system security level matches the item's required security level. If there is a match, the item is transmitted 720, and control loops back to see whether there are any more items waiting in the buffer 714. If the security levels do not match, the item is left in the buffer, and control loops back to see whether there are any more items waiting in the buffer 714.

Items left in the buffer may be transmitted later, when the computer running the daemon is moved to a computing environment supporting matching security levels.

By way of further explanation, an exemplary use case is described with particular reference to FIGS. 1 and 4. In this example, a user connects a computer to a network in a first computing environment. That is, user 160 connects laptop computer 130 to computing environment 132. Assume for purposes of this example that connection 124 is an 802.11b wireless connection to wireless router 104. Wireless router 104 represents a wireless hot spot in a public space such as a coffee shop or an airline terminal.

The user uses the laptop to create data to be sent across network 102, and the user specifies a security level for the data to be sent across the network. In this example, the user creates data to be sent by typing in an email message such as the one shown at reference 334 on FIG. 4. The user specifies a security level of “wireless encryption—no tunnel” by selecting menu item 324 from menu 312 of the sending program, in this example, the email client illustrated in FIG. 4. The user instructs the sending program to send the data across the network by invoking the ‘Send’ button 315 on the email client.

The email client monitors the available security control between the laptop and the network, compares it with the specified security level for the data, and, in this example, determines that the connection to the network lacks a security control required to meet the specified security level for the data, “wireless encryption—no tunnel.” The email client then buffers the outgoing email message, and the user receives an indication that security control of the first computing environment lacks a security control required for the specified security level. That is, the user receives from the email client, through a pop-up dialogue box, an email message in the user's in-box, or other means, advice that wireless encryption is not available in the first computing environment and that the email message will be held until a more secure computing environment is available.

The user moves 162 the laptop 130 and connects it to the network 102 through a second computing environment 134. The second computing environment has the security control required for the specified security level. The second computing environment 134 is, for example, a corporate computing environment disposed entirely behind a corporate firewall 136 which scrutinizes all data communications in and out of computing environment 134 and includes a security control for wireless encryption without a tunnel. After moving laptop 130 to the second computing environment 134, the user receives an indication that the data, the exemplary email message, has been sent across the network. The indication that the message has been sent may be received through a dialogue box, a copy of the message in the user's ‘Sent’ box, or other means as will occur to those of skill in the art.

In this example, when the computer is connected to the second network, the email client may determine automatically that the second computing environment has the security control required for the specified security level. The email client may then proceed by automatically sending the data across the network promptly upon determining that the second computing environment has the security control required for the specified security level. Alternatively, the email client may present to the user the fact that the second computing environment has the security control required for the specified security level, so that the user receives an affirmative indication, through a dialogue box or an email message, for example, that the second computing environment has the security control required for the specified security level. In such a case, the user may proceed by again instructing the sending program (the email client in this example) to send the data across the network.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A method for providing a necessary level of security for a computer capable of connecting to different computing environments, the method comprising:
monitoring a type of connection between the computer and a network in a current computing environment;
determining a security level of data before sending the data across the network;
storing the data in a buffer instead of sending the data across the network if the connection to the network lacks a security control required for the determined security level of the data; and
sending the data from the buffer when the computer is connected to a changed computing environment having a new type of connection that has the security control required for the data.

2. The method of claim 1 wherein monitoring a type of connection comprises periodically determining the type of connection between the computer and the network.

3. The method of claim 1 wherein monitoring a type of connection comprises event-driven determining of the type of connection between the computer and the network.

4. The method of claim 3 wherein the steps of the method are carried out by a software process and event-driven determining of the type of connection is carried out whenever the process is invoked.

5. The method of claim 3 wherein determining a security level results in a determination that data to be transmitted requires at least some level of security and event-driven determining of the type of connection is carried out in response to such determination.

6. The method of claim 1 wherein determining a security level of data before sending the data across the current network comprises reading the security level of data from a markup element embedded in the data.

7. The method of claim 1 wherein determining a security level of data before sending the data across the current network comprises reading the security level of data from meta-data in a header in a network message.

8. The method of claim 1 further comprising returning a non-fatal error to a sending program if the connection to the network lacks a security control required for the data.

9. The method of claim 8 further comprising the sending program's informing a user that the data will be held in a security buffer until the computer is connected to a changed computing environment having a new type of connection that has the security control required for the data.

10. The method of claim 8 further comprising the sending program's prompting a user with the option to create a secure tunnel for transmission of the data.

11. A method for providing a necessary level of security for a computer capable of connecting to different computing environments, the method comprising:
connecting the computer to a network in a first computing environment;
specifying a security level for data to be sent across the network;
instructing a sending program to send the data across the network;
receiving an indication that security control of the first computing environment lacks a security control required for the specified security level;
connecting the computer to the network in a second computing environment, wherein the second computing environment has the security control required for the specified security level; and
receiving an indication that the data has been sent across the network.

12. The method of claim 11 further comprising:
determining, when the computer is connected to the second network, that the second computing environment has the security control required for the specified security level; and
automatically sending the data across the network promptly upon determining that the second computing environment has the security control required for the specified security level.

13. The method of claim 11 further comprising:
receiving an indication that the second computing environment has the security control required for the specified security level; and
again instructing the sending program to send the data across the network.

14. A system for providing a necessary level of security for a computer capable of connecting to different computing environments, the system comprising:
means for monitoring a type of connection between the computer and a network in a current computing environment;
means for determining a security level of data before sending the data across the network;
means for storing the data in a buffer instead sending the data across the network if the connection to the network lacks a security control required for the determined security level of the data; and
means for sending the data from the buffer when the computer is connected to a changed computing environment having a new type of connection that has the security control required for the data.

15. The system of claim 14 wherein means for monitoring a type of connection comprises means for periodically determining the type of connection between the computer and the network.

16. The system of claim 14 wherein means for monitoring a type of connection comprises means for event-driven determining of the type of connection between the computer and the network.

17. The system of claim 16 wherein elements of the system are operated by a software process and means for event-driven determining of the type of connection is operated whenever the process is invoked.

18. The system of claim 16 wherein operation of the means for determining a security level results in a determination that data to be transmitted requires at least some level of security and means for event-driven determining of the type of connection operates in response to such determination.

19. The system of claim 14 wherein means for determining a security level of data before sending the data across the current network comprises means for reading the security level of data from a markup element embedded in the data.

20. The system of claim 14 wherein means for determining a security level of data before sending the data across the current network comprises means for reading the security level of data from meta-data in a header in a network message.

21. The system of claim 14 further comprising means for returning a non-fatal error to a sending program if the connection to the network lacks a security control required for the data.

22. The system of claim 21 further comprising means for the sending program to inform a user that the data will be held in a security buffer until the computer is connected to a changed computing environment having a new type of connection that has the security control required for the data.

23. The system of claim 21 further comprising means for the sending program to prompt a user with the option to create a secure tunnel for transmission of the data.

24. A system for providing a necessary level of security for a computer capable of connecting to different computing environments, the system comprising:
means for connecting the computer to a network in a first computing environment;
means for specifying a security level for data to be sent across the network;
means for instructing a sending program to send the data across the network;
means for receiving an indication that security control of the first computing environment lacks a security control required for the specified security level;
means for connecting the computer to the network in a second computing environment, wherein the second computing environment has the security control required for the specified security level; and
means for receiving an indication that the data has been sent across the network.

25. The system of claim 24 further comprising:
means for determining, when the computer is connected to the second network, that the second computing environment has the security control required for the specified security level; and
means for automatically sending the data across the network promptly upon determining that the second computing environment has the security control required for the specified security level.

26. The system of claim 24 further comprising:
means for receiving an indication that the second computing environment has the security control required for the specified security level; and
means for again instructing the sending program to send the data across the network.

27. A computer program product for providing a necessary level of security for a computer capable of connecting to different computing environments, the computer program product comprising:
a recording medium;
means, recorded on the recording medium, for monitoring a type of connection between the computer and a network in a current computing environment;
means, recorded on the recording medium, for determining a security level of data before sending the data across the network;
means, recorded on the recording medium, for storing the data in a buffer instead sending the data across the network if the connection to the network lacks a security control required for the determined security level of the data; and
means, recorded on the recording medium, for sending the data from the buffer when the computer is connected to a changed computing environment having a new type of connection that has the security control required for the data.

28. The computer program product of claim 27 wherein means for monitoring a type of connection comprises means, recorded on the recording medium, for periodically determining the type of connection between the computer and the network.

29. The computer program product of claim 27 wherein means for monitoring a type of connection comprises means, recorded on the recording medium, for event-driven determining of the type of connection between the computer and the network.

30. The computer program product of claim 29 wherein elements of the system are operated by a software process and the means for event-driven determining of the type of connection is executed whenever the process is invoked.

31. The computer program product of claim 29 wherein execution of the means for determining a security level results in a determination that data to be transmitted requires at least some level of security and means for event-driven determining of the type of connection executes in response to such determination.

32. The computer program product of claim 27 wherein means for determining a security level of data before sending the data across the current network comprises means, recorded on the recording medium, for reading the security level of data from a markup element embedded in the data.

33. The computer program product of claim 27 wherein means for determining a security level of data before sending the data across the current network comprises means, recorded on the recording medium, for reading the security level of data from meta-data in a header in a network message.

34. The computer program product of claim 27 further comprising means, recorded on the recording medium, for returning a non-fatal error to a sending program if the connection to the network lacks a security control required for the data.

35. The computer program product of claim 34 further comprising means, recorded on the recording medium, for the sending program to inform a user that the data will be held in a security buffer until the computer is connected to a changed computing environment having a new type of connection that has the security control required for the data.

36. The computer program product of claim 34 further comprising means, recorded on the recording medium, for the sending program to prompt a user with the option to create a secure tunnel for transmission of the data.

37. A computer program product for providing a necessary level of security for a computer capable of connecting to different computing environments, the computer program product comprising:
a recording medium;
means, recorded on the recording medium, for connecting the computer to a network in a first computing environment;
means, recorded on the recording medium, for specifying a security level for data to be sent across the network;
means, recorded on the recording medium, for instructing a sending program to send the data across the network;
means, recorded on the recording medium, for receiving an indication that security control of the first computing environment lacks a security control required for the specified security level;
means, recorded on the recording medium, for connecting the computer to the network in a second computing environment, wherein the second computing environment has the security control required for the specified security level; and
means, recorded on the recording medium, for receiving an indication that the data has been sent across the network.

38. The computer program product of claim 37 further comprising:
means, recorded on the recording medium, for determining, when the computer is connected to the second network, that the second computing environment has the security control required for the specified security level; and
means, recorded on the recording medium, for automatically sending the data across the network promptly upon determining that the second computing environment has the security control required for the specified security level.

39. The computer program product of claim 37 further comprising:
means, recorded on the recording medium, for receiving an indication that the second computing environment has the security control required for the specified security level; and
means, recorded on the recording medium, for again instructing the sending program to send the data across the network.
